(19) United States
(12) Patent Application Publication
(10) Pub. No.: US 2011/0229815 A1
(43) Pub. Date: Sep. 22, 2011

(54) LIGHT FIXABLE TONER AND TWO-COMPONENT DEVELOPER

(76) Inventor: Masahiko KUBO, Osaka-shi (JP)

(21) Appl. No.: 13/048,285

(22) Filed: Mar. 15, 2011

(30) Foreign Application Priority Data
Mar. 17, 2010 (JP) P2010-061692

(51) Int. Cl. G03G 9/08

(52) U.S. Cl. 430/108.3; 430/105; 430/108.4

(57) ABSTRACT

A light fixable toner which is not containing an infrared absorbent and fixed by light irradiation, and a two-component developer containing the light fixable toner are provided. The light fixable toner contains a binder resin, a colorant and an internal additive having an average particle size of 0.50 μm or more and 1.40 μm or less, and a shape factor SF-2 is 105 or more and 120 or less, a relative refractive index n_{b}/nₐ which is a ratio of an absolute refractive index n_{b} of the internal additive to an absolute refractive index nₐ of the binder resin is 0.90 or more and 0.97 or less.

### CROSS-REFERENCE TO RELATED APPLICATION

This application claims priority to Japanese Patent Application No. 2010-061692, which was filed on Mar. 17, 2010, the contents of which are incorporated herein by reference in its entirety.

### BACKGROUND OF THE TECHNOLOGY

### 1. Field of the Technology

The present technology relates to a light fixable toner and a two-component developer.

Electrophotography is an image forming method comprising forming an electrostatic latent image on a photosensitive drum utilizing photoconductive phenomenon, developing the electrostatic latent image with a toner to form a toner image (visible image), transferring the toner image to a recording paper, and fixing the transferred toner image to the recording paper. Various fixing devices utilizing heat, pressure or light are used to fix a toner image. For example, a fixing device using a heating roller is most commonly used.

However, the fixing device using a heating roller has high heat efficiency, but involves loss time of several tens of seconds in the initial heating (initial rising) of the device. In addition, the fixing device using a heating roller has a problem to easily contaminate a recording paper by offset of a residual toner on the heating roller. Furthermore, the fixing device using a heating roller nips a recording paper with a pair of rollers, and therefore has a further problem that wrinkles, break and the like due to snaking are easily to cause in a recording paper in the case where a continuous paper is used as the recording paper.

A fixing device utilizing pressure has advantages such that warming up, a heat source and the like are not necessary, and is therefore noted. However, the fixing device utilizing pressure has the difficulty to strongly fix a toner image to a recording paper. In addition, the fixing device utilizing pressure pressurizes a recording paper by passing the recording paper between a pair of rollers, and therefore has a problem that wrinkles, break and the like due to snaking are easily to cause in the recording paper in the case where a continuous paper is used as the recording paper. Furthermore, the fixing device utilizing pressure has a problem that a paste spreads out of a background by pressure in the case where a self-sticking paper for label formation widely used in recent years is used as a recording paper.

On the other hand, a fixing device utilizing energy of flash light of a xenon lamp or the like is that a toner selectively absorbs light energy, and therefore a toner image can be fixed at high speed. In addition, the fixing device utilizing energy of flash light can conduct fixing of a toner image to a recording paper in non-contact, and therefore has the advantages that wrinkles, break and the like due to snaking of a recording paper are free of worries, a paste does not spread out of a self-sticking paper in fixing a toner image to the self-sticking paper, and the toner image is easily fixed to the paper.

However, the fixing by flash light has a problem that a black toner can sufficiently be fixed, but fixability of a color toner is low. The black toner is possible to absorb light in the overall wavelength region, and due to this, absorbs flash light (light having peak of intensity in a range of from 800 nm to 1,000 nm) by a xenon lamp, thereby temperature is sufficiently increased. However, the color toner hardly absorbs light having a wavelength in a range of from 800 nm to 1,000 nm, and as a result, temperature is difficult to be increased.

As a toner to overcome the problem, Japanese Unexamined Patent Publication JP-A 11-38667 (1999) describes a color toner having added thereto an infrared absorbent absorbing light in a near-infrared region (region having a wavelength of from 800 nm to 1,000 nm). However, the infrared absorbent absorbing light in a near-infrared region also absorbs light in a visible light region (region having a wavelength of 780 nm or less). Therefore, where a large amount of the infrared absorbent is added to a toner to improve light absorption efficiency of the toner, absorption amount of light in a visible light region is also increased, and this gives arise to a problem that color reproducibility of a toner image fixed (fixed image) is decreased.

To overcome the problem, Japanese Unexamined Patent Publication JP-A 2008-107576 describes an image forming apparatus comprising a flash fixing device and a laser fixing device. The image forming apparatus described in JP-A 2008-107576 performs that a toner is heated with flash light by the flash fixing device, and each color toner is irradiated with laser light having the maximum absorption wavelength of the each color toner by the laser fixing device, thereby heat-fixing the toner. According to the image forming apparatus described in JP-A 2008-107576, the amount of an infrared absorbent added to a toner can be reduced, and as a result, color reproducibility of a fixed image is improved.

However, the toner described in JP-A 2008-107576 still contains an infrared absorbent, resulting in decreasing color reproducibility of a fixed image. Furthermore, the image forming apparatus described in JP-A 2008-107576 requires two devices of a flash fixing device and a laser fixing device, as a fixing device. This gives rise to the problems that an apparatus constitution is complicated, and cost is increased.

### SUMMARY OF THE TECHNOLOGY

The technology has been made to solve the problems as described above, and an object thereof is to provide a light fixable toner which is not containing an infrared absorbent and fixed by light irradiation, and a two-component developer containing the light fixable toner.

The technology provides a light fixable toner for use in a fixing method of fixing a toner on a recording medium by irradiation of light having a wavelength within an absorption wavelength range of a colorant, not containing an infrared absorbent, the light fixable toner comprising:

a binder resin;

a colorant; and

an internal additive having an average particle size of 0.50 μm or more and 1.40 μm or less, a shape factor SF-2 being 105 or more and 120 or less, and

a relative refractive index n_{b}/nₐ which is a ratio of an absolute refractive index n_{b} of the internal additive to an absolute refractive index nₐ of the binder resin being 0.90 or more and 0.97 or less.

A toner is a light fixable toner comprising a binder resin, a colorant and an internal additive, and the light fixable toner does not contain an infrared absorbent. Further, an average particle size of the internal additive contained in the toner is 0.50 μm or more and 1.40 μm or less.

When a toner particle is irradiated with light, a part of the light is reflected by the surface of the toner particle and the remains thereof enter into the toner particle. At the time, when an incident angle of the light becomes smaller, a reflection light amount decreases, and thus a light amount entered into the toner particle increases. The toner has the shape factor SF-2 of 105 or more and 120 or less, and thus, there are few irregularities on the surface of the toner particle. Accordingly, in the entire light directed into the toner particle, a rate of the light whose incident angle is small increases, and the reflection light amount decreases as the result. Thereby, the toner enables more light to be entered into the toner particle.

The light entered into the toner particle collides with the colorant so that a part thereof is absorbed into the colorant, or collides with the internal additive so as to be reflected and transmitted, or alternatively, there is a case of transmitting the toner particle colliding with neither the colorant nor the internal additive. A relative refractive index n_{b}/nₐ which is a ratio of an absolute refractive index n_{b} of the internal additive to an absolute refractive index nₐ of the binder resin is 0.97 or less, the light collided with the internal additive is mostly reflected by the internal additive, and a part thereof transmits through the internal additive.

Therefore, since there is the internal additive inside the toner particle, the light entered into the toner particle and reflected repeatedly inside the toner particle increases. Thereby the light easily collides with the colorant, and thus a light amount absorbed by the colorant increases.

Further, since the relative refractive index n_{b}/nₐ is 0.90 or more, such a case that the light entered into one toner particle is reflected and thus most of the light is absorbed in the inside of the one toner particle does not occur, and emission of the light toward the outside of the one toner particle occurs. Therefore, in the case where a toner image is formed by a plurality of toner layers, the light transmitted through a toner layer which is directly irradiated with light is directed to a toner layer which is not directly irradiated with light. Thereby, in all the toner layers, the colorant inside the toner particle is capable of absorbing a sufficient amount of light.

As described above, the toner has the large amount of light to be absorbed into the colorant, whereby the colorant absorbing the light generates heat, and thus the binder resin is heated and fused so as to be able to be fixed on a recording medium. Accordingly, the toner which is not containing the infrared absorbent is able to be fixed on a recording medium by light irradiation. Further, since the toner has the shape factor SF-2 of 105 or more, cleaning property is high.

Further, it is preferable that the light fixable toner is a cyan toner, a magenta toner, or a yellow toner.

The light fixable toner is a cyan toner, a magenta toner or a yellow toner. A black toner is a toner which exhibits a color of black by absorbing light in a visible light region, and therefore, even when an infrared absorbent is contained in the toner, reduction in color reproducibility is difficult to occur. However, each of the color toners is a toner whose colorant absorbs light within a specific absorption wavelength range so as to be employed as a primary color of color mixture. Therefore, where an infrared absorbent is contained in the toner, the infrared absorbent absorbs light of a wavelength region required for color reproduction, resulting in reduction in color reproducibility.

As described above, the toner is an infrared absorbent-free light fixable toner, and therefore does not induce reduction in color reproducibility due to the infrared absorbent. Consequently, an image having goad image quality can be obtained.

Further, it is preferable that the internal additive is a cross-linked methyl methacrylate resin particle or a cross-linked silicone resin particle.

The internal additive is preferably a cross-linked methyl methacrylate resin particle or a cross-linked silicone resin particle. Since the internal additive is such a cross-linked fine resin particle, the internal additive is easily dispersed into a toner base particle uniformly, and moreover, the shape of the internal additive is easily maintained in the toner base particle. Thereby fixability of the toner as a whole is able to be further improved.

Further, the technology provides a two-component developer comprising the light fixable toner mentioned above and a carrier.

A two-component developer comprising the light fixable toner can be realized. The two-component developer can be used in a fixing method of fixing a toner to a recording medium by irradiation of light having a wavelength in an absorption wavelength range of a colorant.

The technology provides a method of manufacturing a light fixable toner, comprising:

a mixing step of mixing a binder resin, a colorant and an internal additive having an average particle size of 0.50 μm or more and 1.40 μm or less to obtain a mixture of the binder resin, the colorant and the internal additive;

a melt-kneading step of melt-kneading the mixture obtained by the mixing step to obtain a melt-kneaded product;

a cooling step of cooling the melt-kneaded product obtained by the melt-kneading step to obtain a solidified product; and

a pulverization step of pulverizing the solidified product obtained by the cooling step to obtain colored resin particles; and

a spheronization treatment step of performing spheronization treatment of the colored resin particles obtained by the pulverizing step so that a shape factor SF-2 thereof is 105 or more and 120 or less, a relative refractive index n_{b}/nₐ which is a ratio of an absolute refractive index n_{b} of the internal additive to an absolute refractive index nₐ of the binder resin being 0.90 or more and 0.97 or less.

The above-described light fixable toner which is not containing the infrared absorbent and fixed on a recording medium by light irradiation, is able to be manufactured.

### BRIEF DESCRIPTION OF THE DRAWINGS

Other and further objects, features, and advantages will be more explicit from the following detailed description taken with reference to the drawings wherein:

FIG. 1 is a process chart showing manufacturing steps of a toner by a melt-kneading pulverization method;

FIG. 2 is a schematic view schematically showing the constitution of an image forming apparatus;

FIG. 3 is a schematic diagram schematically showing the configuration of a developing device; and

FIG. 4 is a schematic view schematically showing the constitution of a fixing section.

### DETAILED DESCRIPTION

Now referring to the drawings, preferred embodiments are described below.

### 1. Toner

### (1) Toner

The toner according to the embodiment is a light fixable toner, and is fixed to a recording medium without containing an infrared absorbent by irradiation of light having a wavelength in an absorption wavelength range of a colorant. The infrared absorbent refers to an infrared absorbent used in the conventional light fixable toner, and examples thereof include cyanine compounds, polymethine compounds, aminium compounds, diimonium compounds, phthalocyanine compounds, merocyanine compounds, benzene-thiol metal complexes, mercaptophenol metal complexes, aromatic diamine metal complexes, nickel complex compounds, anthraquinone compounds, naphthalocyanine compounds and indolenine compounds.

The toner according to the embodiment contains a binder resin, a colorant and an internal additive, and a shape factor SF-2 thereof is 105 or more and 120 or less. In the embodiment below, a toner is composed of a toner base particle containing the binder resin, the colorant and the internal additive, and an external additive which is externally added to the toner base particle, and the shape factor SF-2 of the toner refers to the shape factor SF-2 of the toner base particle. The shape factor SF-2 of the toner base particle is measured as described below.

<Shape Factor SF-2 of Toner Base Particles>

Metal film (Au film, film thickness: 0.5 μm) is formed on surfaces of the toner base particles by sputter deposition to form metal-coated particles. Using a scanning electron microscope (trade name: S-570, manufactured by Hitachi, Ltd.), 200 to 300 metal-coated particles are randomly extracted from the metal-coated particles obtained above under the conditions of an accelerating voltage of 5 kV and 1,000-fold magnification, and a photo shoot is conducted. The pieces of photograph data obtained are image-analyzed with an image analyzing software (trade name: A-ZO KUN, manufactured by Asahi Nasal Engineering Corporation). Particle analyzing parameters of the image analyzing software “A-ZO KUN” are as follows.

Small graphic removal area: 100 pixels

Contraction separation: Number of times 1

Small graphic: 1

Number of times: 10

Noise removal filer: None

Shading: None

Expression unit of result: μm

Values calculated and obtained from the following expressions (A) and (B) using a maximum length (absolute maximum length) MXLNG, a peripheral length PERT and an graphic area (projected area) AREA of the particles obtained by image analysis are used as a shape factor SF-1 and a shape factor SF-2 of a toner.

Shape factor SF-1={(MXLNG)²/AREA}×25×π (A)

Shape factor SF-2={(PERI)²/AREA}×(25/π) (B)

wherein π represents a circular constant.

The shape factor SF-1 is a value represented by the above expression (A), and indicates sphericity (degree of roundness) of a shape of a particle. When the value of the shape factor SF-1 is 100, the shape of a particle is a true sphere. The shape becomes amorphous with increasing the value of the shape factor SF-1. The shape factor SF-2 is a value represented by the above expression (B), and indicates degree of irregularity of surface shape of a particle. When the shape of a particle is a true sphere, the shape factor SF-2 is 100.

When a toner particle is irradiated with light, a part of the light is reflected by the surface of the toner particle and the remains thereof enter into the toner particle. At the time, when an incident angle of the light becomes smaller, a reflection light amount decreases, and thus a light amount entered into the toner particle increases. As described above, the toner according to the embodiment has the shape factor SF-2 of 105 or more and 120 or less, there are few irregularities on the surface of the toner particle. Accordingly, in the entire light directed into the toner particle, a rate of the light whose incident angle is small increases, and the reflection light amount decreases as the result. Thereby, the toner according to the embodiment enables more light to be entered into the toner particle.

Concerning the internal additive, an average particle size is 0.50 μm or more and 1.40 μm or less, and a relative refractive index n_{b}/nₐ which is a ratio of an absolute refractive index n_{b} of the internal additive to an absolute refractive index nₐ of the binder resin is 0.90 or more and 0.97 or less. The internal additive is dispersed into the binder resin along with the colorant.

The light entered into the toner particle by light irradiation collides with the colorant so that a part thereof is absorbed into the colorant, or collides with the internal additive so as to be reflected and transmitted, or alternatively, there is a case of transmitting the toner particle colliding with neither the colorant nor the internal additive. In the embodiment, a relative refractive index n_{b}/nₐ which is a ratio of an absolute refractive index n_{b} of the internal additive to an absolute refractive index nₐ of the binder resin is 0.97 or less, the light collided with the internal additive is mostly reflected by the internal additive, and a part thereof transmits through the internal additive. Therefore, since there is the internal additive inside the toner particle, the light entered into the toner particle and reflected repeatedly inside the toner particle increases. Thereby the light easily collides with the colorant, and thus a light amount absorbed by the colorant increases.

Further, in the embodiment, since the relative refractive index n_{b}/nₐ is 0.90 or more, such a case that the light entered into one of the toner particle is reflected and thus most of the light is absorbed in the inside of the one of the toner particle does not occur, and emission of the light toward the outside of the one of the toner particle occurs. Therefore, in the case where a toner image is formed by a plurality of toner layers, the light transmitted through a toner layer which is directly irradiated with light is directed to a toner layer which is not directly irradiated with light. Thereby, in all the toner layers, the colorant inside the toner particle is capable of absorbing a sufficient amount of light.

As described above, the toner according to the embodiment has the large amount of light to be absorbed to the colorant, whereby the colorant absorbing the light generates heat, and thus the binder resin is heated and fused so as to be able to be fixed on a recording medium. Accordingly, the toner according to the embodiment which is not containing the infrared absorbent is able to be fixed on a recording medium by light irradiation.

On the other hand, when the relative refractive index n_{b}/nₐ exceeds 0.97, reflection of light due to the internal additive is hard to occur, and therefore, securing sufficient amount of the light to be absorbed into the colorant is difficult. Furthermore, when the relative refractive index n_{b}/nₐ is less than 0.9, the light inside the toner particle is difficult to be emitted from the inside of the toner particle, and therefore, in the case where a toner image is formed by a plurality of toner layers, a toner in a toner layer which is not directly irradiated with light is difficult to be fused sufficiently.

Moreover, even though the relative refractive index n_{b}/nₐ is 0.90 or more and 0.97 or less, when the average particle size of the internal additive is not in a range of 0.50 μm or more and 1.40 μm or less, sufficient fixability is not able to be obtained. When the average particle size of the internal additive is less than 0.50 μm, reflection of the light due to the internal additive is difficult to occur, and therefore securing sufficient amount of the light to be absorbed in the colorant is difficult. Furthermore, when the average particle size of the internal additive exceeds 1.40 μm, the light inside the toner particle becomes difficult to be emitted from the inside of the toner particle and therefore, in the case where a toner image is composed of a plurality of toner layers, a toner in a toner layer which is not directly irradiated with light becomes difficult to be fused sufficiently.

The toner according to the embodiment preferably has the shape factor SF-2 of 105 or more. With the shape factor SF-2 of 105 or more, a toner remained on a photoreceptor drum after image formation is easily removed from the photoreceptor drum. That is, with the shape factor SF-2 of 105 or more, cleaning property of the toner is able to be improved.

In the toner according to the embodiment, an internal additive is preferably a cross-linked fine resin particle such as a cross-linked methyl methacrylate resin particle or a cross-linked silicone resin particle. By using the cross-linked fine resin particle as the internal additive, the internal additive is easily dispersed into the toner base particle uniformly, and moreover, the shape of the internal additive is easily maintained in the toner base particle. Thereby, the fixability of the entire toner is able to be improved.

The toner according to the embodiment is preferably a color toner such as a cyan toner, a magenta toner, or a yellow toner. A black toner is a toner which exhibits a color of black by absorbing light in a visible light region, and therefore even when an infrared absorbent is contained in the toner, reduction in color reproducibility is difficult to occur. On the other hand, each of the color toners is a toner whose colorant absorbs light within a specific absorption wavelength range so as to be employed as a primary color of color mixture, therefore, when the infrared absorbent is contained in the toner, the infrared absorbent absorbs the light in a wavelength region required for color reproduction, resulting in reduction in the color reproducibility. As described above, the toner according to the embodiment is an infrared absorbent free light fixable toner, and therefore does not induce reduction in the color reproducibility due to the infrared absorbent. Accordingly, when the toner according to the embodiment is a color toner, it is possible to realize a color toner with which an image of excellent image quality is able to be obtained.

The toner according to the embodiment can be produced by the following toner manufacturing method from the following toner raw materials.

### (2) Toner Raw Materials

Toner raw materials comprise a binder resin, a colorant, an internal additive, and other additives.

### (2-1) Binder Resin

The binder resin is not particularly limited, and the binder resin for black toner or color toner may be used. Examples of the binder resin include: polyester resin; styrene resin such as polystyrene and styrene-acrylic ester copolymer resin; acrylic resin such as polymethylmethacrylate (PMMA); polyolefin resin such as polyethylene; polyurethane resin; epoxy resin; and silicone resin.

The absolute refractive index nₐ of the binder resin is, for example, that a polyester resin is 1.58, a styrene-acrylic resin is 1.56, PMMA is 1.49, and a silicone resin is 1.41.

The binder resin may contain fluorine so that the absolute refractive index nₐ is lowered. As a component containing a fluorine atom in the case of decreasing the absolute refractive index nₐ of a polyester resin, for example, among diol components, an ethylene oxide adduct of 2,2-bis(4-hydroxyphenyl)hexafluoropropane or the like is able to be employed. Furthermore, in order to increase the absolute refractive index nₐ of the polyester resin, for example, a dicarboxylic component having a naphthalene skeleton and a glycol component having a bisphenol A skeleton may be contained as copolymer components.

The absolute refractive index nₐ of the binder resin can be measured by the conventional prism coupling method. For example, Abbe refractomer NAR-1T SOLID (manufactured by Atago Co., Ltd.) is used for the measurement by employing a light-source lamp of D ray (589 nm) at a measurement temperature of 20° C.

### (2-2) Colorant

The colorant includes dyes and pigments. Among them, pigments are preferably used. Pigments have excellent light resistance and color forming property as compared with dyes. Therefore, a toner having excellent light resistance and color forming property can be obtained by using pigments.

Examples of the colorant include a yellow toner colorant, a magenta toner colorant, a cyan toner colorant, and black toner colorant.

Examples of the yellow toner colorant include organic pigments such as C.I. Pigment Yellow 1, C.I. Pigment Yellow 5, C.I. Pigment Yellow 12, C.I. Pigment Yellow 15, C.I. Pigment Yellow 17, C.I. Pigment Yellow 74, C.I. Pigment Yellow 93, C.I. Pigment Yellow 180 and C.I. Pigment Yellow 185; inorganic pigments such as yellow iron oxide and yellow ocher; nitro dyes such as C.I. Acid Yellow 1; and oil-soluble dyes such as C.I. Solvent Yellow 2, C.I. Solvent Yellow 6, C.I. Solvent Yellow 14, C.I. Solvent Yellow 15, C.I. Solvent Yellow 19 and C.I. Solvent Yellow 21, that are classified by a color index.

Examples of the magenta toner colorant include C.I. Pigment Red 49, C.I. Pigment Red 57, C.I. Pigment Red 81, C.I. Pigment Red 122, C.I. Pigment Red 184, C.I. Pigment Red 185, C.I. Pigment Red 238, C.I. Pigment Red 269, C.I. Solvent Red 19, C.I. Solvent Red 49, C.I. Solvent Red 52, C.I. Basic Red 10 and C.I. Disperse Red 15, that are classified by a color index.

Examples of the cyan toner colorant include C.I. Pigment Blue 15, C.I. Pigment Blue 16, C.I. Solvent Blue 55, C.I. Solvent Blue 70, C.I. Direct Blue 25, and C.I. Direct Blue 86.

Examples of the black toner colorant include carbon black such as channel black, roller black, disk black, gas furnace black, oil furnace black, thermal black, and acetylene black.

In addition to the above-described colorants, bright red pigments, green pigments and the like can be used. The colorants may be used each alone, or two or more having different colors may be used in combination. Furthermore, plural colorants of the same color series can be used.

The colorant is preferably used as a masterbatch. The masterbatch of a colorant can be produced by, example, kneading a melt of a binder resin and a colorant. The binder resin used in the masterbatch is the same kind of a resin as the binder resin of a toner. Proportions used of the binder resin and the colorant in the masterbatch are not particularly limited, but the colorant is preferably used in a range of from 30 parts by weight 100 parts by weight based on 100 parts by weight of the binder resin. Particle size of the masterbatch is not particularly limited. However, preferably the masterbatch is granulated into, for example, particles having a particle size of from about 2 mm to 3 mm, and such particles are used.

Content of the colorant in a toner is not particularly limited. However, the colorant is preferably used in a range of 4 parts by weight or more and 20 parts by weight or less based on 100 parts by weight of the binder resin. Use of the colorant in this range can suppress filler effect due to addition of the colorant and can obtain a toner having high coloring power. On the other hand, where the content of the colorant in a toner exceeds 20 parts by weight, fixability of a toner may be decreased due to the filler effect.

### (2-3) Internal Additive

The internal additive is fine resin particles contained in toner base particle. The internal additive may be inorganic fine particles or organic fine particles. In the case of the inorganic fine particles, a silica fine particle (absolute refractive index: 1.45) is able to be used as the internal additive. In the case of the organic fine particle, a fine resin particle is able to be used as the internal additive. The fine resin particle is preferably a cross-linked fine resin particle. As the cross-linked fine resin particle, for example, a cross-linked methyl methacrylate resin particle (absolute refractive index: 1.49), a cross-linked silicone resin particle (absolute refractive index: 1.41) or the like is able to be used.

The internal additive is selected corresponding to the binder resin so that the relative refractive index n_{b}/nₐ which is the ratio of the absolute refractive index n_{b} of the internal additive to the absolute refractive index nₐ of the binder resin becomes 0.90 or more and 0.97 or less. The absolute refractive index n_{b} of the internal additive is able to be measured by a known prism coupling method. For example, Abbe refractometer NAR-IT SOLID (manufactured by Atago Co., Ltd.) is used for the measurement by employing a light-source lamp of D ray (589 nm) at a measurement temperature of 20° C.

The internal additive has the average particle size of 0.50 μm or more and 1.40 μm or less. In this embodiment, the average particle size of the internal additive is a value obtained by measuring a largest diameter of each of 100 pieces of internal additive particles by a real surface view microscope (trade name: VE-9800, manufactured by Keyence Corporation) at a 20,000-fold magnification and calculating an arithmetic mean of the largest diameters.

An adding amount of the internal additive is preferably 1 part by weight or more and 10 parts by weight or more relative to 100 parts by weight of the toner.

### (2-4) Charge Control Agent

The toner may contain a charge control agent. The charge control agent is added to impart preferable chargeability to the toner. The charge control agent is not particularly limited, and a known charge control agent for controlling a positive charge or for controlling a negative charge is usable.

As the charge control agent for controlling a positive charge, for example, a basic dye, a quaternary ammonium salt, a quaternary phosphonium salt, aminopyrine, a pyrimidine compound, a polynuclear polyamino compound, aminosilane, a nigrosine dye and a derivative thereof, a triphenylmethane derivative, a guanidine salt, ab amidin salt and the like are able to be included.

As the charge control agent for controlling a negative charge, for example, an oil-soluble dye such as oil black and spirone black, a metal-containing azo compound, an azo complex dye, naphthene acid metal salt, a metal complex and metal salt (the metal is chrome, zinc, zirconium or the like) of salicylic acid and a derivative thereof, a boron compound, a fatty acid soap, long-chain alkylcarboxylic salt and a resin acid soap are able to be included.

The charge control agent for controlling a positive charge may be used each alone, or two or more of the charge control agents for controlling a positive charge may be used in combination. Similarly, the charge control agent for controlling a negative charge may be used each alone, or two or more of the charge control agents for controlling a negative charge may be used in combination. When a charge control agent which is incompatible with the binder resin is used, the incompatible charge control agent is preferably used in a range of 0.5 part by weight or more and 5 parts by weight or less, and more preferably used in a range of 0.5 part by weight or more and 3 parts by weight or less, based on 100 parts by weight of the binder resin. When the incompatible charge control agent is contained more than 5 parts by weight relative to 100 parts by weight of the binder resin, a carrier is contaminated and the toner scattering occurs. When the containing amount of the incompatible charge control agent is less than 0.5 part by weight, it is impossible to impart the sufficient chargeability to the toner.

### (2-5) External Additive

As a toner, one in which an external additive is externally added to a toner base particle is preferable. As the external additive, preferably, an inorganic fine particle is able to be used in order to improve fluidity and chargeability. A primary particle size of the external additive is preferably 5 nm to 2 μm, and preferably 5 nm to 500 nm in particular. A specific surface area of the external additive according to the BET method is preferably 20 m²/g to 500 m²/g.

Examples of the inorganic fine particles include silica, titanium oxide, alumina, barium titanate, magnesium titanate, calcium titanate, strontium titanate, zinc oxide, tin oxide, silica sand, clay, mica, wollastonite, diatomaceous earth, chromium oxide, cerium oxide, colcothar, antimony trioxide, magnesium oxide, zirconium oxide, barium sulfate, barium carbonate, calcium carbonate, silicon carbide and silicon nitride.

The external additives are preferably surface-treated with a surface-treating agent. The surface-treated external additives increase hydrophobicity, and therefore can prevent deterioration of fluidity and chargeability under high humidity. Examples of the preferred surface-treating agent include a silane coupling agent, a silylating agent, a silane coupling agent having an alkyl fluoride group, an organic titanate silane coupling agent, an aluminum silane coupling agent, a silicone oil and a modified silicone oil.

### (3) Toner Manufacturing Method

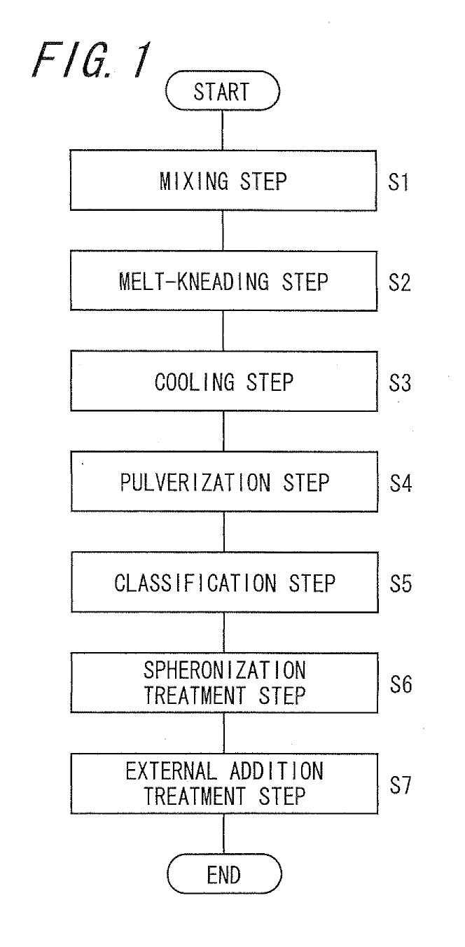

Toner manufacturing method is not particularly limited, and can use a dry process and a wet process. Manufacturing of a toner by a melt-kneading pulverization method that is one of a dry process is described below. FIG. 1 is a process chart showing manufacturing steps of a toner by a melt-kneading pulverization method. Manufacturing steps of a toner by a melt-kneading pulverization method comprise a mixing step S1, a melt-kneading step S2, a cooling step S3, a pulverization step S4, a classification step S5, a spheronization treatment step S6 and an external addition treatment step S7.

### (3-1) Mixing Step S1

At the mixing step S1, the binder resin, the colorant, the internal additive and the charge control agent are subjected to dry mixing. A mixer used for the dry mixing is not particularly limited and a known mixer is able to be used. As the mixer, examples thereof include Henschel type mixers such as HENSCHEL MIXER (trade name, manufactured by Mitsui Mining Co., Ltd.), SUPERMIXER (trade name, manufactured by Kawata Mfg. Co., Ltd.), and MECHANOMILL (trade name, manufactured by Okada Seiko Co., Ltd.); ANGMILL (trade name, manufactured by Hosokawa Micron Corporation); HYBRIDIZATION SYSTEM (trade name, manufactured by Nara Machinery Co., Ltd.); and COSMOSYSTEM (trade name, manufactured by Kawasaki Heavy Industries, Ltd.)

### (3-2) Melt-Kneading Step S2

At the melt-kneading step S2, a mixture obtained at the mixing step S1 is melt-kneaded. At the melt-kneading step S2, the mixture is stirred and kneaded while being heated at a temperature which is the melting temperature or higher of the binder resin and lower than the melting temperature of the internal additive. “The temperature which is the melting temperature or higher of the binder resin and lower than the melting temperature of the internal additive” is about 80° C. to 200° C., and preferably about 100° C. to 150° C. A kneader used for melting and kneading is not particularly limited, and for example, a general kneader such as biaxial extruder, three-roll mill or a laboplast mill is usable. Specific example of the kneader includes a monoaxial or biaxial extruder such as TEM-100B (trade name, manufactured by Toshiba Machine Co., Ltd.) or PCM-65/87 (trade name, manufactured by Ikegai, Ltd.), or the one of the open roll system such as KNEADEX (trade name, manufactured by Mitsui Mining Co., Ltd.)

### (3-3) Cooling Step S3

At the cooling step S3, the melt-kneaded product obtained at the melt-kneading step S2 is cooled and solidified. The cooling may be natural cooling or forcible cooling by means of a cooling device.

### (3-4) Pulverization Step S4

At the pulverization step S4, a solidified product obtained at the cooling step S3 is pulverized. By pulverizing the solidified product, colored resin, particles are obtained. For pulverization of the solidified product, a cutter mill, a feather mill, a jet mill or the like is used. These pulverizers may be used each alone, or two or more of them may be used in combination. For example, the solidified product is coarsely pulverized by the cutter mill and subsequently pulverized finely by the jet mill, whereby colored resin particles having a desirable particle size are able to be obtained.

### (3-5) Classification step S5

At the classification step S5, colored resin particles having a particle size other than the desired particle size are removed from the colored resin particles obtained at the pulverization step S4. At the classification step S5, excessively-pulverized resin particles are removed from a coarse powder obtained in the pulverization step S4 using a classifier. The classifier can use, for example, a rotary classifier such as TSP SEPARATOR (trade name, manufactured by Hosokawa Micron Corporation).

### (3-6) Spheronization Treatment Step S6

At the spheronization treatment step S6, spheronization treatment is performed for the colored resin particle classified at the classification step S5 to produce a toner base particle whose shape factor SF-2 is adjusted to 100 or more and 120 or less. For the spheronization treatment, an impact-type spheronization device or a hot-air-type spheronization device is usable. As the impact-type spheronization device, for example, FACULTY (trade name, manufactured by Hosokawa Micron Corporation), HYBRIDIZATION SYSTEM (trade name, manufactured by Nara Machinery Co., Ltd.) or the like is usable. As the hot-air-type spheronization device, a surface modifying machine, METEORAINBOW (trade name, manufactured by Nippon Pneumatic MFG. Co., Ltd.) or the like is usable. Note that, the colored resin particle generated with the melt-kneading pulverization method usually has an amorphous form before performing the spheronization treatment, and frequently the shape factor SF-1 thereof exceeds 150 and the shape factor SF-2 thereof exceeds 140.

### (3-7) External Addition Treatment Step S7

At the external addition treatment step S7, an external additive is externally added to the toner base particle obtained at the spheronization treatment step S6. For external addition of the external additive, an impact-type pulverizer or various mixers are usable. As the mixer, for example, MECHANOFUSION SYSTEM (trade name, manufactured by Hosokawa Micron Corporation), CYCLOMIX (trade name, manufactured by Hosokawa Micron Corporation), NANO-ACTIVATOR (trade name, manufactured by Hosokawa Micron Corporation), HENSCHEL MIXER (trade name, manufactured by Mitsui Mining Co., Ltd.), MECHANOMILL (trade name, manufactured by Okada Seiko Co., Ltd.) or the like is included.

### 2. Developer

The developer according to the embodiment contains the toner according to the embodiment. The toner according to the embodiment can be used in a one-component developer and can be used in a two-component developer.

### (1) One-Component Developer

A one-component developer is composed of only the toner according to the embodiment without containing a carrier. The one-component developer is conveyed by a developing sleeve, frictionally charged with a blade or a fur brush and supplied to an electrostatic latent image with an electrostatic force, and thereby develops the electrostatic latent image. The one-component developer according to the embodiment is able to be used as a one-component developer in a fixing method of fixing a toner on a recording medium by irradiation of light having the wavelength within the absorption wavelength range of a colorant.

### (2) Two-Component Developer

A two-component developer contains the known carrier along with the toner according to the embodiment. The two-component developer according to the embodiment is able to be used as a two-component developer in a fixing method of fixing a toner on a recording medium by irradiation of light having the wavelength within the absorption wavelength range of a colorant.

Examples of the carrier that can be used include single or composite ferrite carriers composed of iron, copper, zinc, nickel, cobalt, manganese, chromium and the like; resin-coated carriers comprising carrier core particles composed of ferrite, and a coating material covering the surface of the carrier core particles; and resin-dispersed carriers comprising a resin and particles having magnetic property dispersed therein.

The coating material is not particularly limited, and can use the conventional coating materials. Examples of the coating material that can be used include polytetrafluoroethylene, monochlorotrifluoroethylene polymer, polyvinylidene fluoride, silicone resins, polyester resins, metal compounds of di-tert-butylsalicylic acid, styrenic resins, acrylic resins, polyacid, polyvinylal, nigrosine, aminoacrylate resins, basic dyes, lake products of basic dyes, silica fine powder and alumina fine powder. The coating materials are appropriately selected depending on a toner component. The coating materials may be used each alone, or two or more of them may be used in combination.

The resin used in a resin-dispersed carrier is not particularly limited, and examples of the resin that can be used include styrene-acryl resins, polyester resins, fluorine resins and phenolic resins. The resins used in a resin-dispersed carrier are appropriately selected depending on a toner component, and may be used each alone, or two or more of them may be used in combination.

A shape of the carrier is preferably a spherical shape or a flat shape. A particle size of the carrier is not particularly limited. However, considering high quality of a fixed image, the particle size is preferably in a range of from 10 μm to 100 μm, and more preferably a range of from 20 μm to 50 μm.

Resistivity of the carrier is preferably 10⁸ Ω∩cm or more, and more preferably 10¹² Ω∩cm or more. Where the resistivity of the carrier is low, charges are injected in the carrier in applying bias voltage, and carrier particles may be adhered to a photoreceptor drum Furthermore, where the resistivity of the carrier is low, breakdown of bias voltage is liable to occur. The “resistivity of the carrier” used herein means current value when a carrier is placed in a vessel having a sectional area of 0.50 cm² and having an electrode on the bottom, followed by tapping, a load of 1 kg/cm² is applied to the carrier particles filled in the vessel by the weight, and voltage generating electric field of 1,000 V/cm² between the weight and the bottom electrode is applied.

Magnetization intensity (maximum magnetization) of the carrier is preferably in a range of from 10 emu/g to 60 emu/g, and more preferably a range of from 15 emu/g to 40 emu/g. Although depending on flux density of a developing roller, when magnetization intensity of the carrier is less than 10 emu/g under the ordinary flux density conditions, magnetic constraint force does not work, resulting in carrier scatter. Where the magnetization intensity of the carrier exceeds 60 emu/g, brush of the carrier is too high. Where brush of the carrier is too high in non-contact development, a photoreceptor drum and a carrier are difficult to maintain a non-contact state. Where brush of the carrier is too high in contact development, sweep streaks are easily generated in a toner image.

Proportions used of the toner and the carrier in the two-component developer are not particularly limited, and can appropriately be selected depending on the kind of the toner and the carrier. For example, in the case of using a resin-coated carrier (density: 5 g/cm² to 8 g/cm²), preparation is performed such that the toner is contained in the two-component developer in an amount of from 2% by weight to 30% by weight, and preferably from 2% by weight to 20% by weight, based on the weight of the whole amount of the developer. In the two-component developer, the coverage of the carrier by the toner is preferably in a range of from 40% to 80%.

### 3. Image Forming Apparatus

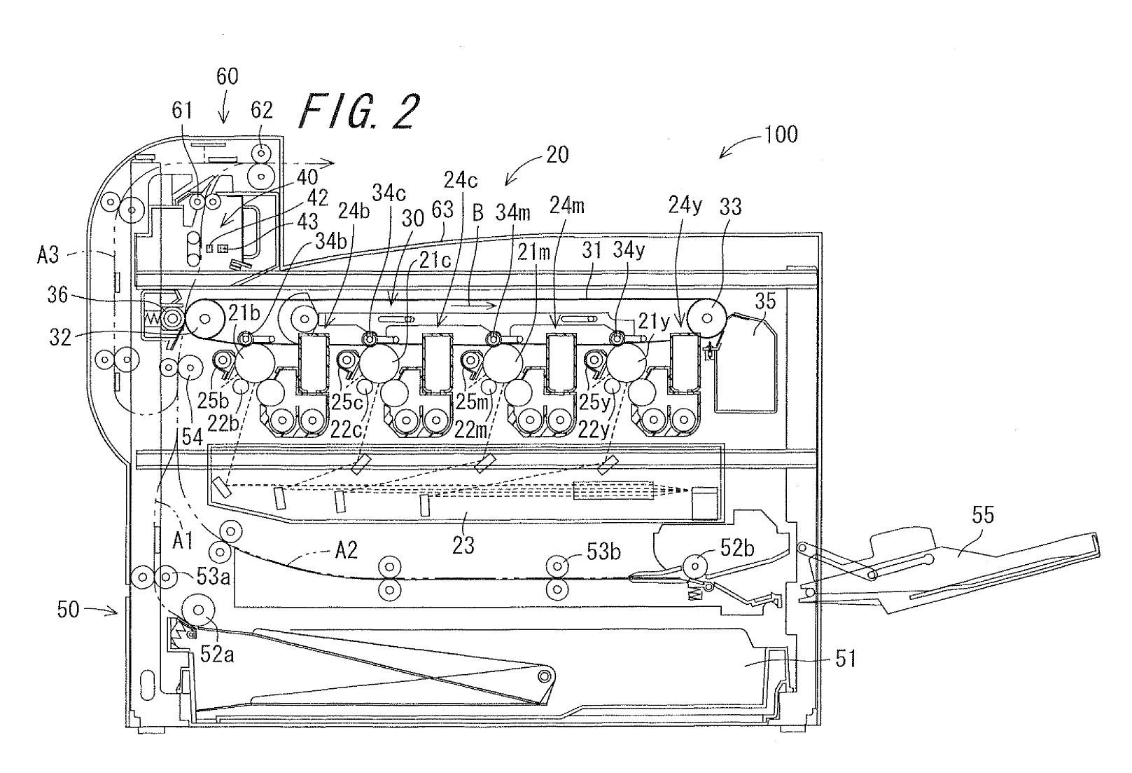

The developer according to the embodiment can be used in a laser fixing image forming apparatus 100 shown in FIG. 2. FIG. 2 is a schematic view schematically showing the constitution of the image forming apparatus 100. The image forming apparatus 100 is a multifunctional peripheral having a copying function, a printer function and a facsimile function in combination, and forms full color or monochrome image on a recording medium according to image information transmitted. The image forming apparatus 100 has three kinds of printing modes of copier mode (copying mode), printer mode and facsimile mode. A printing mode is selected by a control unit section (not shown) according to operation input from an operation part (not shown) and reception of printing job from personal computers, mobile terminal equipments, information recording storage media, external instruments using memories, and the like.

The image forming apparatus 100 comprises a toner image forming section 20, a transfer section 30, a fixing section 40, a recording medium feeding section 50, a discharging section 60, and a control unit section (not shown). The toner image forming section 20 comprises photoreceptor drums 21b, 21c, 21m and 21y, charging sections 22b, 22c, 22m and 22y, an exposure unit 23, developing devices 24b, 24c, 24m and 24y, and cleaning units 25b, 25c, 25m and 25y. The transfer section. 30 comprises an intermediate transfer belt 31, a driving roller 32, a driven roller 33, intermediate transfer rollers 34b, 34c, 34m and 34y, a transfer belt cleaning unit 35 and a transfer roller 36.

Four members are provided for the photoreceptor drum 21, the charging section 22, the developing device 24, the cleaning unit 25 and the intermediate transfer roller 34 in order to respond to image information of each color of black (k), cyan (c), magenta (m) and yellow (y) contained in color image information. In the present description, in the case of distinguishing each member (every four members are provided according to each color), an alphabet showing each color is added to the end of the numeral showing each member to constitute a reference mark. In the case of generic name of each member, only numeral showing each member is shown to constitute a reference mark.

The photoreceptor drum 21 is supported so as to be rotatable around an axis line thereof by a driving section (not shown), and comprises a conductive substrate and a photosensitive layer formed on a surface of the conductive substrate, which are not shown. The conductive substrate can have various shapes, and examples of the shape include a cylindrical shape, a columnar shape and a thin film sheet shape. The photosensitive layer is formed by, for example, laminating a charge generating layer containing a charge generating substance and a charge transporting layer containing a charge transporting substance.

The charging section 22, the developing device 24 and the cleaning unit 25 are arranged in this order around the photoreceptor drum 21 in a rotation direction thereof. The charging section 22 is arranged vertically below the developing device 24 and the cleaning unit 25.

The charging section 22 is a member which charges a surface of the photoreceptor drum 21 to given polarity and potential. The charging section 22 is arranged at a position facing the photoreceptor drum 21 along a longitudinal direction of the photoreceptor drum 21. In the case of a contact-charging type charging device, the charging section 22 is arranged so as to come in contact with the surface of the photoreceptor drum 21. In the case of a non-contact-charging type charging device, the charging section 22 is arranged so as to separate from the surface of the photoreceptor drum 21.

The charging section 22 is arranged around the photoreceptor drum 21 together with the developing device 24, the cleaning unit 25 and the like. The charging section 22 is preferably arranged at a position closer to the photoreceptor drum 21 than the developing device 24, the cleaning unit 25 and the like. In this way, it is possible to securely prevent the occurrence of charging faults of the photoreceptor drum 21.

The charging section 22 can use a brush type charging device, a roller type charging device, a corona discharge device, an ion generating device, and the like. The brush type charging device and the roller type charging device are a contact-charging type charging device. The brush type charging device includes a device using charging brush and a device using magnetic brush. The corona discharge device and the ion generating device are a non-contact-charging type charging device. The corona discharge device includes a device using a wire-like discharge electrode, a device using a pin-array discharge electrode and a device using a needle-like discharge electrode.

The exposure unit 23 is arranged such that light emitted from the exposure unit 23 passes between the charging section 22 and the developing device 24, and illuminates the surface of the photoreceptor drum 21. The exposure unit 23 forms an electrostatic latent image corresponding to image information of each color on the respective surfaces of the photoreceptor drums 21b, 21c, 21m and 21y by irradiating the surfaces of the photoreceptor drums 21b, 21c, 21m and 21y in charged state with laser light corresponding to image information of each color, respectively. The exposure unit 23 can use, for example, a laser scanning unit (LSU) equipped with a laser irradiation part and plural reflective mirrors. The exposure unit 23 may use, for example, a unit comprising an appropriate combination of LED (Light Emitting Diode) array, a liquid crystal shutter and a light source.

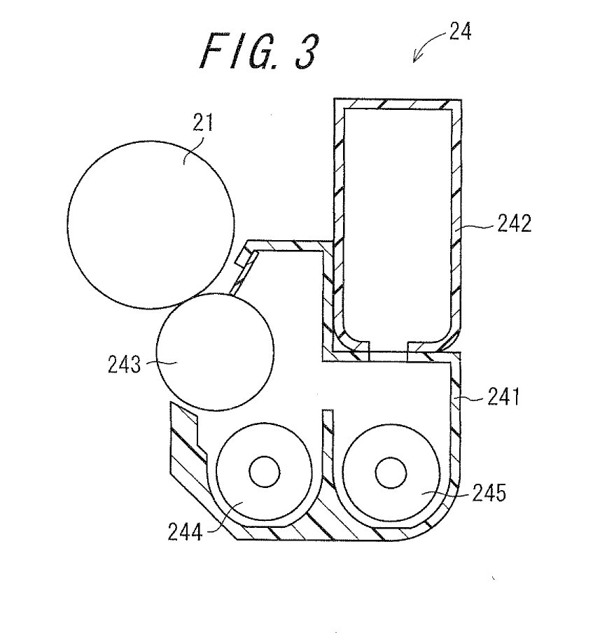

FIG. 3 is a schematic diagram schematically showing the configuration of the developing device 24. The developing device 24 includes a developer tank 241 and a toner hopper 242. The developer tank 241 contains a developer according to the embodiment in an internal space thereof. In the developer tank 241, a developing roller 243, a first conveying screw 244 and a second conveying screw 245 are rotatably supported. On a side surface facing a photoreceptor drum 21 of the developer tank 241, an opening is formed, and a developing roller 243 is disposed on a position opposing to the photoreceptor drum 21 with the opening interposed therebetween.

The developing roller 243 is a member which feeds a toner to an electrostatic latent image on the surface of the photoreceptor drum 21 at the closest part to the photoreceptor drum 21. In feeding a toner, potential having polarity reverse to charged potential of the toner is applied as a developing bias voltage to the surface of the developing roller 243. This facilitates feeding of the toner on the surface of the developing roller 243 to the electrostatic latent image. Changing the value of the developing bias voltage can control the amount of a toner (toner attachment amount) fed to the electrostatic latent image.

The first conveying screw 244 is a member which faces the developing roller 243 and supplies a toner around the developing roller 243. A second conveying screw 245 is a member which faces the first conveying screw 244 and feeds a toner newly supplied from the toner hopper 242 into the developer tank 241 to around the first conveying screw 244. The toner hopper 242 is provided such that a toner replenishment port (not shown) provided on a lower part thereof in the vertical direction and a toner reception port (not shown) provided on an upper part of the developer tank 241 in the vertical direction communicate with each other. The toner hopper 242 replenishes the toner supplied from a toner cartridge (not shown) provided vertically above the developer tank 241 to the developer tank 241 in accordance with a toner consumption state. In another embodiment, the developing device may be configured to replenish a toner directly from each of color toner cartridges to the developer tank 241 without using the toner hopper 242.

A cleaning unit 25 is a member which cleans the surface of the photoreceptor drum 21 by removing a toner remained on the surface of the photoreceptor drum 21 after a toner image is transferred to an intermediate transfer belt 31 from the photoreceptor drum 21. As the cleaning unit 25, for example, a plate-like member for scraping off the toner and a container-like member for collecting the scraped off toner are used.

According to a toner image forming section 20, laser light corresponding to image information is emitted from an exposure unit 23 on the surface of the photoreceptor drum 21 which is in a state of being uniformly charged by the charging section 22 so that an electrostatic latent image is formed. A toner is supplied from the developing device 24 to the electrostatic latent image on the photoreceptor drum 21, whereby a toner image is formed. The toner image is transferred to the intermediate transfer belt 31 which will be described later. The toner remained on the surface of the photoreceptor drum 21 after the toner image is transferred to the intermediate transfer belt 31 is removed by the cleaning unit 25.

The intermediate transfer belt 31 is an endless belt-like member provided vertically above the photoreceptor drum 21. The intermediate transfer belt 31 is supported around the driving roller 32 and the driven roller 33 with tension to form a loop-like path, and is turned to run in a direction of arrow B.

The driving roller 32 is provided so as to be rotatable around an axis line thereof by a driving section (not shown). The driving roller 32 causes the intermediate transfer belt 31 to be turned to run in the arrow B direction by rotation thereof. The driven roller 33 is provided so as to be rotatable following the rotation of the driving roller 32, and generates constant tension in the intermediate transfer belt 31 such that the intermediate transfer belt 31 does not go slack.

The intermediate transfer roller 34 is provided so as to be in pressure-contact with the photoreceptor drum 21 with the intermediate transfer belt 31 interposed therebetween and rotate around an axis line thereof by a driving section (not shown). The intermediate transfer roller 34 has the function that a power source (not shown) for applying transfer bias voltage is connected thereto, thereby transferring a toner image on the surface of the photoreceptor drum 21 to the intermediate transfer belt 31.

The transfer roller 36 is provided so as to be in pressure-contact with the driving roller 32 with the intermediate transfer belt 31 interposed therebetween and rotate around its axis line by a driving section (not shown). In the pressure-contact part (transfer nip region) between the transfer roller 36 and the driving roller 32, a toner image borne on and conveyed by the intermediate transfer belt 31 is transferred to a recording medium delivered from the recording medium feeding section 50 described hereinafter.

The transfer belt cleaning unit 35 opposes to the driven roller 33 with the intermediate transfer belt 31 interposed therebetween, and provided so as to be in contact with a toner image bearing surface of the intermediate transfer belt 31. The transfer belt cleaning unit 35 is provided so as to remove and collect the toner on the surface of the intermediate transfer belt 31 after a toner image has been transferred to a recording medium. When the toner remains adhering to the intermediate transfer belt 31 after the toner image has been transferred to the recording medium, there is a possibility that the residual toner adheres to the transfer roller 36 with turning movement of the intermediate transfer belt 31. When the toner adheres to the transfer roller 36, the toner contaminates the back side of the recording medium which is to be transferred next.

According to the transfer section 30, when the intermediate transfer belt 31 is turned to run while the intermediate transfer belt 31 comes in contact with the photoreceptor drum 21, transfer bias voltage having polarity reverse to charged polarity of a toner on the surface of the photoreceptor drum 21 is applied to the intermediate transfer roller 34, and a toner image formed on the surface of the photoreceptor drum 21 is transferred to the intermediate transfer belt 31. In the case of a full color image, toner images of each color formed on the photoreceptor drum 21y, the photoreceptor drum 21m, the photoreceptor drum 21c and the photoreceptor drum 21b, respectively are sequentially transferred to and overlaid on the intermediate transfer belt 31 in this order, thereby a full color toner image is formed. The toner image transferred to the intermediate transfer belt 31 is conveyed to a transfer nip region by turning movement of the intermediate transfer belt 31, and transferred to a recording medium in the transfer nip region. The recording medium having the toner image transferred thereto is conveyed to the fixing section 40 mentioned later.

The recording medium feeding section 50 includes a paper feed box 51, pick up rollers 52a and 52b, conveying rollers 53a and 53b, registration rollers 54 and a paper feed tray 55. The paper feed box 51 is a container-like member which is provided on a lower part of the image forming apparatus 100 in the vertical direction and stores recording mediums in an inside of the image forming apparatus 100. The paper feed tray 55 is a tray-like member which is provided on an outer wall surface of the image forming apparatus 100 and stores recording mediums on an outside of the image forming apparatus 100. As the recording medium, plain paper, colored copy paper, a sheet for an overhead projector, a post card and the like are included.

The pickup roller 52a is a member for picking up recording mediums stored in the paper feed box 51 sheet by sheet and sending a recording medium to a paper conveyance path A1. The conveying rollers 53a are a pair of roller-like members provided so as to come in pressure-contact with each other, and convey a recording medium toward the registration rollers 54 in the paper conveyance path A1. The pickup roller 52b is a member for picking up recording mediums stored in the paper feed tray 55 sheet by sheet and conveying a recording medium to a paper conveyance path A2. The conveying rollers 53b are a pair of roller-like members provided so as to come in pressure-contact with each other, and convey a recording medium toward the registration rollers 54 in the paper conveyance path A2.

The registration rollers 54 are a pair of roller-like members provided so as to come in pressure-contact with each other, and send a recording medium sent from the conveying rollers 53a and 53b to the transfer nip region in synchronization with conveying a toner image borne on the intermediate transfer belt 31 to the transfer nip region.

According to the recording medium feeding section 50, a recording medium is sent to the transfer nip region from the paper feed box 51 or the paper feed tray 55 in synchronization with conveying a toner image borne on the intermediate transfer belt 31 to the transfer nip region, and a toner image is transferred to the recording medium.

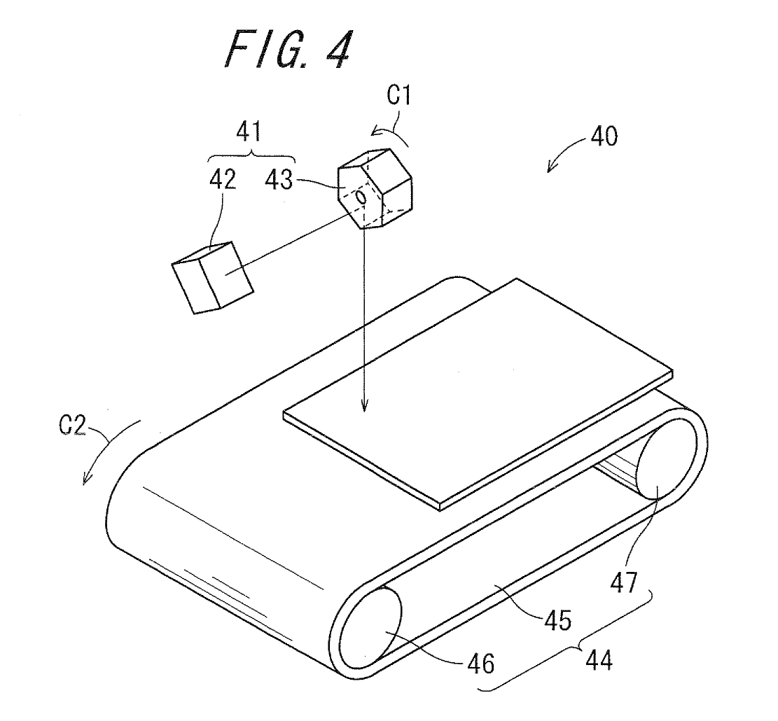

FIG. 4 is a schematic view schematically showing the constitution of the fixing section 40. The fixing section 40 comprises a laser fixing device 41 and a conveying section 44. The laser fixing device 41 comprises a laser light source 42 and a rotary polygon mirror 43. The laser light source 42 is a member for emitting laser light, and is constituted such that four kinds of laser lights having different wavelength as oscillation wavelength are separately outputted, respectively. The rotary polygon mirror 43 reflects laser light emitted from the laser light source 42 and exposes a recording medium to laser light with scanning from nearly vertical direction to a toner-bearing surface of a recording medium. The rotary polygon mirror 43 has a shape of, for example, regular hexagon, and rotates at constant speed in arrow C1 direction. The laser fixing device 41 can locally emit laser light to a toner image on the recording medium.

The conveying section 44 comprises a conveying belt 45, a driving roller 46 and a driven roller 47. The conveying belt 45 is an endless belt-like member. The conveying belt 45 is supported around the driving roller 46 and the driven roller 47 with tension to form a loop-like path, and is turned to run in a direction of arrow C2. The conveying belt 45 may have a constitution that a recording medium is borne on the belt surface by electrostatic force and conveyed, and may have a constitution that a recording medium is borne on the belt surface by wind power and conveyed.

The driving roller 46 is provided so as to be rotatable around an axis line thereof by a driving section (not shown). The driving roller 46 causes the conveying belt 45 to be turned to run in an arrow C2 direction by rotation thereof. The driven roller 47 is rotatably provided so as to be rotatable following the rotation of the driving roller 46, and generates constant tension in the conveying belt 45 such that the conveying belt 45 does not go slack.

A collimator lens, a cylinder lens or the like may be provided in an optical path between the laser light source 42 and the rotary polygon mirror 43. Between the rotary polygon mirror 43 and the conveying belt 45, an fθ lens, a folded mirror, a reflective mirror or the like may be provided.

The laser fixing device 41 emits each laser light having different wavelength to an unfixed toner image held on a recording medium and is thereby able to fix a toner on the recording medium in a non-contact manner. Specifically, a colorant contained in the unfixed toner on the recording medium absorbs the laser light so as to generate heat, and whereby the toner is heated and fused be fixed on the recording medium.

The laser light source 42 comprises a Y-fixing laser light source, an M-fixing laser light source, a C-fixing laser light source and a B-fixing laser light source in order to emit laser lights having different four wavelengths. An oscillation wavelength of the Y-fixing laser light source is absorption peak (for example, 430 nm) of a yellow toner in a visible light region. An oscillation wavelength of the M-fixing laser light source is absorption peak (for example, 565 nm) of a magenta toner in a visible light region. An oscillation wavelength of the C-fixing laser light source is absorption peak (for example, 620 nm) of a cyan toner in a visible light region. An oscillation wavelength of the B-fixing laser light source is not particularly limited, and can appropriately be selected from light absorbed by black toner.

Intensity of laser light emitted from the laser light source 42 is preferably in a range of 1.5 W/cm² or larger and 630 W/cm² or lower. Where the intensity of laser light is lower than 1.5 W/cm², fusion of a toner by laser irradiation becomes insufficient, and as a result, fixation rate of a toner is decreased. Where the intensity of laser light is larger than 630 W/cm², scorch is generated in a toner or a recording medium by laser irradiation, and this decreases fixation rate of a toner.

According to the fixing section 40, when the recording medium having unfixed toner image borne thereon is conveyed to the conveying section 44 from the transfer nip region, at first laser light from the Y-fixing laser light source is selectively emitted to a yellow toner in the unfixed toner image. At this time, laser light from the Y-fixing laser light source is absorbed by the yellow toner. Thereby, the yellow toner is heated and fused. Next, laser light from the M-fixing laser light source is selectively emitted to a magenta toner in the unfixed toner image. At this time, laser light from the M-fixing laser light source is absorbed by the magenta toner. Thereby, the magenta toner is heated and fused.

Next, laser light from the C-fixing laser light source is selectively emitted to a cyan toner in the unfixed toner image. At this time, laser light from the C-fixing laser light source is absorbed by a cyan toner. Thereby, the cyan toner is heated and fused. Finally, laser from the B-fixing laser light source is selectively emitted to a black toner in the unfixed toner image. At this time, laser light from the B-fixing laser light source is absorbed by the black toner. Thereby, the black toner is heated and fused. Thus, unfixed toner images is all heated and fused. As a result, a toner image is fixed to a recording medium and an image is formed. The recording medium having a toner image fixed thereto is conveyed to a discharging section 60 by the conveying section 44.

The discharging section 60 comprises conveying rollers 61, discharge rollers 62 and a catch tray 63. The conveying rollers 61 are a pair of roller-like members provided so as to come in pressure-contact with each other vertically above the fixing section 40. The conveying rollers 61 convey the recording medium having an image fixed thereto toward the discharge rollers 62.

The discharge rollers 62 are a pair of roller-like members provided so as to come in pressure-contact with each other. In the case of one-side printing, the discharge rollers 62 discharge a recording medium having one side printed to the catch tray 63. In the case of double-side printing, the discharge rollers 62 convey a recording medium having one side printed to the registration rollers 54 through a paper conveyance path A3, and discharge the recording medium having both sides printed to the catch tray 63. The catch tray 63 is provided at upper surface in a vertical direction of the image forming apparatus 100, and stores recording mediums having an image fixed thereto.

The image forming apparatus 100 includes a control unit section (not shown). The control unit section is provided, for example, upward in a vertical direction in an inner space of the image forming apparatus 100, and comprises a memory portion, a computing portion and a control portion. Various preset values through an operation panel (not shown) provided in the upper part in a vertical direction of the image forming apparatus 100, detection results from a sensor and the like (not shown) provided in each place inside the image forming apparatus 100, image information from external devices, and the like are inputted in the memory portion of the control unit section. Furthermore, programs for performing various processings are written in the memory portion. Various processings include a recording medium judgment processing, an attachment amount control processing and a fixing condition control processing.

The memory portion can use memories ordinary used in this field, and examples thereof include read-only memory (ROM), random access memory (RAM) and hard disk drive (HDD). The external device can use electric and electronic instruments capable of forming or obtaining image information and capable of electrically connecting to the image forming apparatus 100, and examples thereof include computers, digital cameras, television receivers, video recorders, DVD (Digital Versatile Disc) recorders, HDDVD (High-Definition Digital Versatile Disc) recorders, Blu-ray disc recorders, facsimile apparatuses and mobile terminal devices.

The computing portion retrieves various data (command for image formation, detection result, image information, etc.,) and programs of various processing which are written in the memory portion and performs various determination. The control portion transmits a control signal to each device provided in the image forming apparatus 100 in accordance with the determination results of the computing portion so as to perform operation control.

The control portion and the computing portion include a processing circuit implemented by microcomputers, microprocessors or the like equipped with a central processing unit (CPU). The control unit section includes a main power source together with the above-described processing circuit. The power source supplies electric power to not only the control unit, but each device in the image forming apparatus 100.

### EXAMPLES

Examples are specifically described below.

### 1. Measurement Method of Each Physical Property Value

### (1) Absolute Refractive Index nₐ of Binder Resin

The absolute refractive index nₐ of a binder resin was measured with a prism coupling method. Specifically, Abbe refractomer NAR-1T SOLID (manufactured by Atago Co., Ltd.) was used for the measurement by employing a light-source lamp of D ray (589 nm) at a temperature of 20° C.

### (2) Glass Transition Temperature (Tg) of Binder Resin

A DSC curve was measured by heating 1 g of a sample in a temperature rising rate of 10° C./minute according to JIS K7121-1987 using a differential scanning calorimeter (trade name, DSC220, manufactured by Seiko Instruments & Electronics, Ltd.) Temperature of intersection point between a straight line of extending a base line at high temperature side of an endothermic peak corresponding to a glass transition point of the DSC curve obtained to low temperature side and a tangent line drawn at a point that gradient is maximum to a curve of from a rising portion of a peak to the top was obtained as a glass transition temperature (Tg).

### (3) Softening Temperature (Tm) of Binder Resin

In a fluidity characteristic evaluation apparatus (trade name: FLOW TESTER OFT-100C, manufactured by Shimadzu Corporation), a load of 10 kgf/cm² (9.8×10⁵ Pa) was applied to set such that 1 g of a sample is extruded from a die (nozzle bore: 1 mm, length: 1 mm). The sample was heated in a temperature rising rate of 6° C. per minute, and temperature when a half amount of the sample was flown out of the die was obtained. The temperature was used as a softening temperature (Tm).

### (4) Shape Factor SF-2 of Toner Base Particles

A metal film (Au film, film thickness: 0.5 μm) was formed on the surface of the toner base particles by sputter deposition to form metal-coated particles. Using a scanning electron microscope (trade name: S-570, manufactured by Hitachi, Ltd.), 200 to 300 metal-coated particles were randomly extracted from the metal-coated particles obtained above under the conditions of an accelerating voltage of 5 kV and 1,000-fold magnification, and a photo shoot was conducted. The pieces of photograph data were image-analyzed with an image analyzing software (trade name: A-ZO NUN, manufactured by Asahi Kasei Engineering Corporation). Particle analyzing parameters of the image analyzing software (A-ZO NUN) were as follows.

Small graphic removal area: 100 pixels

Contraction separation: Number of times 1

Small graphic: 1

Number of times: 10

Noise removal filer: None

Shading: None

Expression unit of result: μm

Value calculated and obtained from the following expression (B) using a peripheral length PERI and a graphic area (projected area) AREA of the particles obtained by image analysis was used as a shape factor SF-2 of a toner.

Shape factor SF-2={(PERI)²/AREA}×(25/π) (B)

wherein π represents a circular constant.

### (5) Volume Average Particle Size of Toner Base Particles

To 50 ml of electrolyte (trade name: ISOTON-II, manufactured by Beckman Coulter), 20 g of toner base particles and 1 ml of sodium alkyl ether sulfate were added, followed by dispersion treatment at ultrasonic frequency of 20 kHz for 3 minutes by an ultrasonic disperser (trade name: UH-50, manufactured by SMT Co., Ltd.) Thus, a measurement sample was prepared. The measurement sample was measured under the conditions of aperture diameter: 100 μm and the number of particles measured; 50,000 counts using a particle size distribution measuring instrument (trade name: Multisizer III, manufactured by Beckman Coulter), and volume average particle size was obtained from a volume particle size distribution of toner base particles.

### (6) Absolute Refractive Index n_{b} of Internal Additive

The absolute refractive index n_{b} of the internal additive was measured by a prism coupling method. Specifically, Abbe refractomer NAR-1T SOLID (manufactured by Atago Co., Ltd.) was used for the measurement by employing a light-source lamp of D ray (589 nm) at a temperature of 20° C.

### (7) Average Particle Size of Internal Additive

The average particle size of the internal additive was obtained by measuring a largest diameter of each of 100 pieces of internal additive particles by a real surface view microscope (trade name: VE-9800, manufactured by Keyence Co., Ltd.) at a 20,000-fold magnification and calculating an arithmetic mean of the largest diameters.

### 2. Examples and Comparative Examples

### (1) Example 1

### (1-1) Production of Toner

By a mixer (trade name: HENSCHEL MIXER, manufactured by Mitsui Mining Co., Ltd.), 100 parts by weight of a binder resin (polyester resin, absolute refractive index: 1.58, glass transition temperature: 60° C., softening temperature: 110° C.), 4.0 parts by weight of an internal additive (cross-linked methyl methacrylate resin particle, absolute refractive index: 1.49, average particle size: 0.90 μm), 6.0 parts by weight of a colorant (C.I. Pigment Blue 111, manufactured by DIC Corporation), and 2.0 parts by weight of a charge control agent (alkyl salicylate metal salt, trade name: BONTRON E-84, manufactured by Orient Chemical Industries Ltd.) were mixed for 10 minutes, and thereafter, the mixture was melt-kneaded by a biaxial kneading extruder (trade name: PCM-65, manufactured by Ikegai, Ltd.).

The obtained melt-kneaded product was finely pulverized by means of a counter jet mill (trade name: COUNTER JET MILL AFG, manufactured by Hosokawa Micron Corporation), and subsequently, classified with a rotary classifier (trade name: TSP SEPARATOR, manufactured by Hosokawa Micron Corporation) to produce colored resin particles having a volume average particle size of 5.5 μm. Spheronization treatment of the colored resin particles was implemented by the surface modifying machine: METEORAINBOW (trade name, manufactured by Nippon Pneumatic MFG. Co., Ltd.) which was a hot-air-type spheronization device. In the surface modifying machine, METEORAINBOW, an input amount of the pulverized products (colored resin particles) was 3.0 kg per hour, a supplying amount of hot air was 900 L per minute, a temperature of the hot air was 185° C., supplying pressure of cooling air was 0.15 MPa, and a supplying amount of air from a secondary air ejecting nozzle was 230 L per minute. Furthermore, a distance L between a cooling air intake port and a collision member was 2.0 cm. The speronization processing was performed in this manner, and the shape factor SF-2 of the obtained toner base particles was 112. Subsequently, the toner base particles and hydrophobic silica which was 1.0 part by weight relative to 100 parts by weight of the toner base particles were mixed by the Henschel mixer so as to obtain toner particles to which hydrophobic silica was externally added.

### (1-2) Production of Two-Component Developer

The obtained toner and a ferrite core carrier having a volume average particle size of 45 μm were mixed for 20 minutes using a V-mixer (trade name: V-5, manufactured by Tokuju Corporation) so that a toner concentration in a two-component developer was 7%, thereby producing a two-component developer according to Example 1. In Example 1, the shape factor SF-2 of the toner base particles was 112, the absolute refractive index nₐ of the binder resin was 1.58, the average particle size of the internal additive was 0.90 μm, the absolute refractive index n_{b} of the internal additive was 1.49, and the relative refractive index n_{b}/nₐ was 1.49/1.58 which was approximately 0.94.

### (2) Example 2

A two-component developer according to Example 2 was produced in the same manner as Example 1 except that the temperature of the hot air was changed to 180° C. in the spheronization treatment of the colored resin particles. In Example 2, the shape factor SF-2 of the toner base particles was 119, the absolute refractive index nₐ of the binder resin was 1.58, the average particle size of the internal additive was 0.90 μm, the absolute refractive index n_{b} of the internal additive was 1.49, and the relative refractive index n_{b}/nₐ was 1.49/1.58 which was approximately 0.94.

### (3) Example 3

A two-component developer according to Example 3 was produced in the same manner as Example 1 except that the temperature of the hot air was changed to 210° C. in the spheronization treatment of the colored resin particles. In Example 3, the shape factor SF-2 of the toner base particle was 106, the absolute refractive index nₐ of the binder resin was 1.58, the average particle size of the internal additive was 0.90 μm, the absolute refractive index n_{b} of the internal additive was 1.49, and the relative refractive index n_{b}/nₐ was 1.49/1.58 which was approximately 0.94.

### (4) Example 4

A two-component developer according to Example 4 was produced in the same manner as Example 1 except that 3.0 parts by weight of the cross-linked methyl methacrylate resin particles with the average particle size of 0.50 μm were used as the internal additive. In Example 4, the shape factor SF-2 of the toner base particles was 112, the absolute refractive index nₐ of the binder resin was 1.58, the average particle size of the internal additive was 0.50 μm, the absolute refractive index n_{b} of the internal additive was 1.49, and the relative refractive index nₕ/nₐ was 1.49/1.58 which was approximately 0.94.

### (5) Example 5

A two-component developer according to Example 5 was produced in the same manner as Example 1 except that 3.0 parts by weight of the cross-linked methyl methacrylate resin particles with the average particle size of 1.40 μm were used as the internal additive. In Example 5, the shape factor SF-2 of: the toner base particles was 112, the absolute refractive index nₐ of the binder resin was 1.58, the average particle size of the internal additive was 1.40 μm, the absolute refractive index n_{b} of the internal additive was 1.49, and the relative refractive index nₕ/nₐ was 1.49/1.58 which was approximately 0.94.

### (6) Example 6

A two-component developer according to Example 6 was produced in the same manner as Example 1 except that 100 parts by weight of a polyester resin containing fluorine (absolute refractive index: 1.54, glass transition temperature: 62° C., softening temperature: 111° C.) were used as the binder resin. In Example 6, the shape factor SE-2 of the toner base particles was 112, the absolute refractive index nₐ of the binder resin was 1.54, the average particle size of the internal additive was 0.90 μm, the absolute refractive index n_{b} of the internal additive was 1.49, and the relative refractive index n_{b}/nₐ was 1.49/1.54 which was approximately 0.97.

### (7) Example 7

A two-component developer according to Example 7 was produced in the same manner as Example 1 except that 100 parts by weight of a styrene acrylic resin (absolute refractive index: 1.56, glass transition temperature: 61° C., softening temperature: 110° C.) were used as the binder resin, and 4.0 parts by weight of the cross-linked silicone resin particles with the average particle size of 0.90 μm and the absolute refractive index of 1.41. In Example 7, the shape factor SF-2 of the toner base particles was 112, the absolute refractive index nₐ of the binder resin was 1.56, the average particle size of the internal additive was 0.90 μm, the absolute refractive index n_{b} of the internal additive was 1.41, and the relative refractive index n_{b}/nₐ was 1.41/1.56 which was approximately 0.90.

### (8) Comparative Example 1

A two-component developer according to Comparative Example 1 was produced in the same manner as Example 1 except that the temperature of the hot air was changed to 175° C. in the spheronization treatment of the colored resin particles. In Comparative Example 1, the shape factor SF-2 of the toner base particles was 121, the absolute refractive index nₐ of the binder resin was 1.58, the average particle size of the internal additive was 0.90 μm, the absolute refractive index n_{b} of the internal additive was 1.49, and the relative refractive index n_{b}/nₐ was 1.49/1.58 which was approximately 0.94.

### (9) Comparative Example 2

A two-component developer according to Comparative Example 2 was produced in the same manner as Example 1 except that the temperature of the hot air was changed to 230° C. in the spheronization treatment of the colored resin particles. In Comparative Example 2, the shape factor SF-2 of the toner base particles was 104, the absolute refractive index nₐ of the binder resin was 1.58, the average particle size of the internal additive was 0.90 μm, the absolute refractive index n_{b} of the internal additive was 1.49, and the relative refractive index n_{b}/nₐ was 1.49/1.58 which was approximately 0.94

### (10) Comparative Example 3

A two-component developer according to Comparative Example 3 was produced in the same manner as Example 1 except that 3.0 parts by weight of the cross-linked methyl methacrylate resin particles with the average particle size of 0.40 μm were used as the internal additive. In Comparative Example 3, the shape factor SF-2 of the toner base particles was 112, the absolute refractive index nₐ the binder resin was 1.58, the average particle size of the internal additive was 0.40 μm, the absolute refractive index n_{b} of the internal additive was 1.49, and the relative refractive index n_{b}/nₐ was 1.49/1.58 which was approximately 0.94.

### (11) Comparative Example 4

A two-component developer according to Comparative Example 4 was produced in the same manner as Example 1 except that 3.0 parts by weight of the cross-linked methyl methacrylate resin particles with the average particle size of 1.60 μm were used as the internal additive. In Comparative Example 4, the shape factor SE-2 of the toner base particles was 112, the absolute refractive index nₐ of the binder resin was 1.58, the average particle size of the internal additive was 1.60 μm, the absolute refractive index n_{b} of the internal additive was 1.49, and the relative refractive index n_{b}/nₐ was 1.49/1.58 which was approximately 0.94.

### (12) Comparative Example 5

A two-component developer according to Comparative Example 5 was produced in the same manner as Example 1 except that 100 parts by weight of a polyester resin (absolute refractive index: 1.60, glass transition temperature: 60° C., softening temperature: 110° C.) were used as the binder resin, and 3.0 parts by weight of the cross-linked silicone resin particles with the average particle size of 0.90 μm and the absolute refractive index of 1.41. In Comparative Example 5, the shape factor SF-2 of the toner base particles was 112, the absolute refractive index nₐ of the binder resin was 1.60, the average particle size of the internal additive was 0.90 μm, the absolute refractive index n_{b} of the internal additive was 1.41, and the relative refractive index n_{b}/nₐ was 1.41/1.60 which was approximately 0.88.

### (13) Comparative Example 6

A two-component developer according to Comparative Example 6 was produced in the same manner as Example 1 except that 100 parts by weight of a polyester resin containing fluorine (absolute refractive index: 1.52, glass transition temperature: 60° C., softening temperature: 111° C.) was used as the binder resin. In Comparative Example 6, the shape factor SF-2 of the toner base particles was 112, the absolute refractive index nₐ of the binder resin was 1.52, the average particle size of the internal additive was 0.90 μm, the absolute refractive index n_{b} of the internal additive was 1.49, and the relative refractive index n_{b}/nₐ was 1.49/1.52 which was approximately 0.98.

### 3. Evaluation

### (1) Evaluation of Fixability of Toner

Using the two-component developers according to Examples and Comparative Examples, unfixed solid images of 20 cm vertical and 20 cm horizontal were prepared by adjusting such that the toner attachment amount is 1.2 mg/cm² (corresponding to two layers of capsule toner). Using a copying machine in which a fixing device of the commercially available copying machine (trade name: MX-2700, Sharp Corporation) was modified into a fixing device (Y-fixing laser light source: 430 nm, M-fixing laser light source: 565 nm, C-fixing laser light source: 620 nm, B-fixing laser light source: 780 nm, power of each light source: 30 W), the unfixed solid image was irradiated, with laser light. In a Gakushin-type fastness rubbing test, surface of a fixed image was rubbed with an ink eraser (trade name: LION ERASER GAZA SUNA, manufactured by Lion Office Products Corp.) having a load of 1 kg placed herein three reciprocations in a speed of 14 mm/second. Optical reflection density (image density) before and after rubbing was measured using a reflective densitometer (trade name: RD-914, manufactured by MacBeth). Fixation rate was calculated based on the following expression (D), and fixability of a toner was evaluated.

Fixation rate (%)=[(image density after rubbing)/(image density before rubbing)]×100 (D)

Evaluation standard of the fixability is as follows.

Excellent: Very favorable. Fixation rate (%) is 85% or more.

Good: Favorable. Fixation rate (%) is 70% or more and less than 85%.

Poor: No good. Fixation rate (%) is less than 70%.

### (2) Evaluation of Cleaning Property of Toner

Evaluation of cleaning property was performed by forming an image as described above, visually comparing the formed images at respective stages of after printing 1 sheet and after printing 5000 (5K) sheets, and checking sharpness of an edge part between an image part and a non-image part, and presence/absence of black streaks formed by leakage of the toner in the rotation direction of the photoreceptor drum.

The evaluation standard for the cleaning property is as follows.

Good: Favorable. After printing 5K sheets, the edge part is sharp and no black streak is observed.

Poor: No good. After printing 5K sheets, the edge part is unsharp or black streaks are observed.

The shape factor SF-2 of the toner base particles, the absolute refractive index nₐ of the binder resin, the average particle size of the internal additive, the absolute refractive index n_{b} of the internal additive, the relative refractive index n_{b}/nₐ, evaluation results of the fixation rate and the fixability, and evaluation results of the cleaning property are shown in Table 1.

TABLE 1

| | Absolute | Shape | Average particle | Absolute | Relative | Evaluation result | | Evaluation result |
|---|---|---|---|---|---|---|---|---|
| | refractive | factor | size of internal | refractive index | refractive index | of fixation rate | | of cleaning |
| | index nₐ | SF-2 | additive | n_{b} | n_{b}/nₐ | and fixability | | property |
| Example 1 | 1.58 | 112 | 0.90 μm | 1.49 | 0.94 | 84% | Good | Good |
| Example 2 | 1.58 | 119 | 0.90 μm | 1.49 | 0.94 | 74% | Good | Good |
| Example 3 | 1.58 | 106 | 0.90 μm | 1.49 | 0.94 | 92% | Excellent | Good |
| Example 4 | 1.58 | 112 | 0.50 μm | 1.49 | 0.94 | 73% | Good | Good |
| Example 5 | 1.58 | 112 | 1.40 μm | 1.49 | 0.94 | 72% | Good | Good |
| Example 6 | 1.54 | 112 | 0.90 μm | 1.49 | 0.97 | 71% | Good | Good |
| Example 7 | 1.56 | 112 | 0.90 μm | 1.41 | 0.90 | 73% | Good | Good |
| Comparative | 1.58 | 121 | 0.90 μm | 1.49 | 0.94 | 68% | Poor | Good |
| Example 1 | | | | | | | | |
| Comparative | 1.58 | 104 | 0.90 μm | 1.49 | 0.94 | 94% | Excellent | Poor |
| Example 2 | | | | | | | | |
| Comparative | 1.58 | 112 | 0.40 μm | 1.49 | 0.94 | 67% | Poor | Good |
| Example 3 | | | | | | | | |
| Comparative | 1.58 | 112 | 1.60 μm | 1.49 | 0.94 | 66% | Poor | Good |
| Example 4 | | | | | | | | |
| Comparative | 1.60 | 112 | 0.90 μm | 1.41 | 0.88 | 65% | Poor | Good |
| Example 5 | | | | | | | | |
| Comparative | 1.52 | 112 | 0.90 μm | 1.49 | 0.98 | 68% | Poor | Good |
| Example 6 | | | | | | | | |

It is understood from table 1 that the fixability is high when the shape factor SF-2 is 100 or more and 120 or less, the average particle size of the internal additive is 0.50 μm or more and 1.40 μm or less, and the relative refractive index n_{b}/nₐ is 0.90 or more and 0.97 or less. Furthermore, it is understood that the cleaning property is high when the shape factor SF-2 is 105 or more.

The technology may be embodied in other specific forms without departing from the spirit or essential characteristics thereof. The present embodiments are therefore to be considered in all respects as illustrative and not restrictive, the scope of the technology being indicated by the appended claims rather than by the foregoing description and all changes which come within the meaning and the range of equivalency of the claims are therefore intended to be embraced therein.

What is claimed is:

1. A light fixable toner for use in a fixing method of fixing a toner on a recording medium by irradiation of light having a wavelength within an absorption wavelength range of a colorant, not containing an infrared absorbent, the light fixable toner comprising:
a binder resin;
a colorant; and
an internal additive having an average particle size 0.50 μm or more and 1.40 μm or less,
a shape factor SF-2 being 105 or more and 120 or less, and
a relative refractive index n_{b}/nₐ which is a ratio of an absolute refractive index n_{b} of the internal additive to an absolute refractive index nₐ of the binder resin being 0.90 or more and 0.97 or less.

2. The light fixable toner of claim 1, wherein the light fixable toner is a cyan toner, a magenta toner, or a yellow toner.

3. The light fixable toner of claim 1, wherein the internal additive is a cross-linked methyl methacrylate resin particle or a cross-linked silicone resin particle.

4. A two-component developer comprising the light fixable toner of claim 1 and a carrier.
